(19) United States
(12) Patent Application Publication
(10) Pub. No.: US 2006/0149604 A1
(43) Pub. Date: Jul. 6, 2006

(54) Custom and collaborative risk assessment templates and associated methods of use

(75) Inventor: Craig D. Miller, Savannah, GA (US)

Correspondence Address: DOUGHERTY CLEMENTS, 1901 ROXBOROUGH ROAD, SUITE 300, CHARLOTTE, NC, 28211, US

(73) Assignee: TMG TEMPLATES LLC

(21) Appl. No.: 11/325,035

(22) Filed: Jan. 4, 2006

Related U.S. Application Data
(60) Provisional application No. 60/641,476, filed on Jan. 5, 2005.

(51) Int. Cl. G06Q 40/00; G06Q 99/00

(52) U.S. Cl. 705/4; 705/1

(57) ABSTRACT

The present invention provides generally computerized custom and collaborative risk assessment templates for use in litigation risk assessment and the like. More specifically, the present invention provides computerized custom and collaborative risk assessment templates that present one or more users with a plurality of questions that are used to create and/or select and modify the functionality and appearance of subsequently-displayed decision analysis tools. These computerized custom and collaborative risk assessment templates may be accessed locally via a personal computer (PC), laptop computer, personal digital assistant (PDA), mobile processing device, or the like; via an intranet or the like; and/or via the Internet or the like.

### CROSS-REFERENCE TO RELATED APPLICATION

The present non-provisional patent application claims the benefit of priority of U.S. Provisional Patent Application No. 60/641,476, entitled “CUSTOM AND COLLABORATIVE RISK ASSESSMENT TEMPLATES,” and filed on Jan. 5, 2005, which is herein incorporated in full by reference.

### FIELD OF THE INVENTION

The present invention relates generally to computerized custom and collaborative risk assessment templates for use in litigation risk assessment and the like. More specifically, the present invention relates to computerized custom and collaborative risk assessment templates that present one or more users with a plurality of questions that are used to create and/or select and modify the functionality and appearance of subsequently-displayed decision analysis tools. These computerized custom and collaborative risk assessment templates may be accessed locally via a personal computer (PC), laptop computer, personal digital assistant (PDA), mobile processing device, or the like; via an intranet or the like; and/or via the Internet or the like.

### BACKGROUND OF THE INVENTION

Various risk assessment and decision analysis tools, such as decision trees, Monte Carlo simulations, forecasting methods, linear and nonlinear programming optimization methods, and the like, are well known to those of ordinary skill in the art. Such risk assessment and decision analysis tools are used to manage the complexity of and uncertainty inherent in decision making. In the litigation risk assessment context, for example, decision trees are used to show key litigation events and possible final litigation outcomes based upon the probability of each of these key litigation events, and given combinations thereof, occurring. Several conventional software programs incorporate and use decision trees, Monte Carlo simulations, forecasting methods, linear and nonlinear programming optimization methods, and the like. Such software programs include, for example, TreeAge Pro (Litigation Risk Analysis, Inc.), DecisionPro (Vanguard Software Corporation), the Computer-Aided Case Evaluation system (Litigation Risk Analysis, Inc.), and Arborist (Texas Instruments, Inc.).

None of the above-referenced software programs, nor any other software program known to those of ordinary skill in the art, however, provide custom risk assessment templates. Each of the above-referenced software programs suffers from a general lack of customizability. In other words, each of the software programs provides only “cookie cutter” risk assessment templates and/or fails to identify and highlight project-specific issues and/or risks that require special attention. The risk assessment templates are simply “pre-packaged” risk assessment templates. In addition, none of the above-referenced software programs allow for truly collaborative risk assessment involving a plurality of users. These shortcomings result in imperfect decision making, which may result in financial losses.

Thus, what are needed are computerized custom and collaborative risk assessment templates that present one or more users with a plurality of questions that are used to create and/or select and modify the functionality and appearance of subsequently-displayed decision analysis tools. In other words, what are needed are computerized custom and collaborative risk assessment templates that provide decision analysis tools that are actually designed and formulated using the answers to the plurality of questions that are presented to the one or more users, as well as using predetermined logic and/or modeling rules. Thus, the computerized custom and collaborative risk assessment templates would be selectively designed and formulated for a specific dispute, claim, or case. This represents a novel analytical step. What are also needed are computerized custom and collaborative risk assessment templates that may be accessed locally via a personal computer (PC), laptop computer, personal digital assistant (PDA), mobile processing device, or the like; via an intranet or the like; and/or via the Internet or the like. The computerized custom and collaborative risk assessment templates of the present invention fulfill these needs.

### BRIEF SUMMARY OF THE INVENTION

In one exemplary embodiment of the present invention, a computerized method for assessing and evaluating the issues and risks associated with a project in a custom manner includes presenting a plurality of questions related to the issues and risks associated with the project to a user; receiving a plurality of answers related to the issues and risks associated with the project from the user; creating one or more custom decision analysis tools and/or selecting and modifying the functionality and appearance of one or more existing decision analysis tools based upon the answers related to the issues and risks associated with the project received from the user; and displaying the one or more created and/or selected and modified decision analysis tools to the user for subsequent issue and risk assessment and evaluation by the user.

In another exemplary embodiment of the present invention, a computerized system for assessing and evaluating the issues and risks associated with a project in a custom manner includes output means for presenting a plurality of questions related to the issues and risks associated with the project to a user; input means for receiving a plurality of answers related to the issues and risks associated with the project from the user; processing means for creating one or more custom decision analysis tools and/or selecting and modifying the functionality and appearance of one or more existing decision analysis tools based upon the answers related to the issues and risks associated with the project received from the user; and display means for displaying the one or more created and/or selected and modified decision analysis tools to the user for subsequent issue and risk assessment and evaluation by the user.

In a further exemplary embodiment of the present invention, a computerized method for assessing and evaluating the issues and risks associated with a project in a collaborative manner includes presenting a plurality of questions related to the issues and risks associated with the project to a plurality of users; receiving a plurality of answers related to the issues and risks associated with the project from the plurality of users; creating one or more custom decision analysis tools and/or selecting and modifying the functionality and appearance of one or more existing decision analysis tools based upon the answers related to the issues and risks associated with the project received from the plurality of users; and displaying the one or more created and/or selected and modified decision analysis tools to the plurality of users for subsequent issue and risk assessment and evaluation by the plurality of users.

In a still further exemplary embodiment of the present invention, a computerized system for assessing and evaluating the issues and risks associated with a project in a collaborative manner includes output means for presenting a plurality of questions related to the issues and risks associated with the project to a plurality of users; input means for receiving a plurality of answers related to the issues and risks associated with the project from the plurality of users; processing means for creating one or more custom decision analysis tools and/or selecting and modifying the functionality and appearance of one or more existing decision analysis tools based upon the answers related to the issues and risks associated with the project received from the plurality of users; and display means for displaying the one or more created and/or selected and modified decision analysis tools to the plurality of users for subsequent issue and risk assessment and evaluation by the plurality of users.

### BRIEF DESCRIPTION OF THE DRAWINGS

The present invention is illustrated and described herein with reference to the various drawings, in which like reference numbers, wherein used, denote like system components or method steps, and in which:

FIG. 1 illustrates an input display screen associated with the computerized custom risk assessment templates of the present invention, the display screen requesting risk assessment information from a user;

FIG. 2 illustrates another input display screen associated with the computerized custom risk assessment templates of the present invention, the display screen requesting risk assessment information from the user;

FIG. 3 illustrates a further input display screen associated with the computerized custom risk assessment templates of the present invention, the display screen requesting risk assessment information from the user;

FIG. 4 illustrates a still further input display screen associated with the computerized custom risk assessment templates of the present invention, the display screen requesting risk assessment information from the user;

FIG. 5 illustrates a still further input display screen associated with the computerized custom risk assessment templates of the present invention, the display screen requesting risk assessment information from the user;

FIG. 6 illustrates a still further input display screen associated with the computerized custom risk assessment templates of the present invention, the display screen requesting risk assessment information from the user;

FIG. 7 illustrates an output display screen associated with the computerized custom risk assessment templates of the present invention, the display screen providing risk assessment information to the user;

FIG. 8 illustrates another output display screen associated with the computerized custom risk assessment templates of the present invention, the display screen providing risk assessment information to the user;

FIG. 9 illustrates a further output display screen associated with the computerized custom risk assessment templates of the present invention, the display screen providing risk assessment information to the user;

FIG. 10 illustrates a still further output display screen associated with the computerized custom risk assessment templates of the present invention, the display screen providing risk assessment information to the user;

FIG. 11 illustrates the basic processes associated with the computerized collaborative risk assessment templates of the present invention using a list;

FIG. 12 illustrates the basic processes associated with the computerized collaborative risk assessment templates of the present invention using a flowchart;

FIG. 13 illustrates an output display screen associated with the computerized collaborative risk assessment templates of the present invention, the display screen providing risk assessment information to a plurality of users;

FIG. 14 illustrates another output display screen associated with the computerized collaborative risk assessment templates of the present invention, the display screen providing risk assessment information to the plurality of users;

FIG. 15 illustrates a further output display screen associated with the computerized collaborative risk assessment templates of the present invention, the display screen providing risk assessment information to the plurality of users;

FIG. 16 illustrates a still further output display screen associated with the computerized collaborative risk assessment templates of the present invention, the display screen providing risk assessment information to the plurality of users;

FIG. 17 illustrates a still further output display screen associated with the computerized collaborative risk assessment templates of the present invention, the display screen providing risk assessment information to the plurality of users;

FIG. 18 illustrates the basic functionalities associated with the computerized collaborative risk assessment templates of the present invention using a list;

FIG. 19 illustrates an output display screen associated with the computerized collaborative risk assessment templates of the present invention, the display screen providing risk assessment information to the plurality of users;

FIG. 20 illustrates another output display screen associated with the computerized collaborative risk assessment templates of the present invention, the display screen providing risk assessment information to the plurality of users;

FIG. 21 illustrates a further output display screen associated with the computerized collaborative risk assessment templates of the present invention, the display screen providing risk assessment information to the plurality of users;

FIG. 22 illustrates a still further output display screen associated with the computerized collaborative risk assessment templates of the present invention, the display screen providing risk assessment information to the plurality of users;

FIG. 23 illustrates a still further output display screen associated with the computerized collaborative risk assessment templates of the present invention, the display screen providing risk assessment information to the plurality of users;

FIG. 24 illustrates a still further output display screen associated with the computerized collaborative risk assessment templates of the present invention, the display screen providing risk assessment information to the plurality of users; and

FIG. 25 illustrates a still further output display screen associated with the computerized collaborative risk assessment templates of the present invention, the display screen providing risk assessment information to the plurality of users.

### DETAILED DESCRIPTION OF THE INVENTION

In various exemplary embodiments, the present invention provides computerized custom and collaborative risk assessment templates for use in litigation risk assessment and the like. More specifically, the present invention provides computerized custom and collaborative risk assessment templates that present one or more users with a plurality of questions that are used to create and/or select and modify the functionality and appearance of subsequently-displayed decision analysis tools. These computerized custom and collaborative risk assessment templates may be accessed locally via a personal computer (PC), laptop computer, personal digital assistant (PDA), mobile processing device, or the like; via an intranet or the like; and/or via the Internet or the like.

In the litigation risk assessment context, for example, many companies are confronted with an inventory of claims and/or cases that each raise the same types of issues and/or risks. Individually, these claims and/or cases may be relatively small and insignificant. In the aggregate, however, the claims and/or cases may represent significant potential financial exposure. The assessment, evaluation, and management of such inventories presents an ongoing and expensive challenge.

In various exemplary embodiments, the present invention provides computerized custom risk assessment templates that represent a powerful, structured, and consistent architecture for assessing, evaluating, and managing inventories of claims and/or cases, identifying and highlighting claim and/or case-specific issues and/or risks that require special attention. These computerized custom risk assessment templates create and incorporate decision analysis tools to further six basic objectives: 1) the efficient and cost-effective assessment and evaluation of risk; 2) the identification of claims and/or cases that require special attention; 3) the assurance that risk assessments and evaluations are performed in a careful manner; 4) the documentation of risk assessments and evaluations; 5) the assurance that risk assessments and evaluations are performed in a consistent manner, such that resulting risk data are comparable and may be aggregated for corporate reporting and/or future risk management; and 6) increased accuracy.

Through the completion of the computerized custom risk assessment templates of the present invention, a user creates a risk profile for a claim or case that includes an identification of the percentage probability and the dollar amount of each of a plurality of potential outcomes, and the risk-adjusted weighted average of all of the potential outcomes (the “expected value”). The computerized custom risk assessment templates also elicit other critical information. While the types of additional information vary according to user preference, factors that warrant special attention to the claim or case are preferably identified. In the litigation risk assessment context, for example, the incurred and projected litigation costs, the probability of winning any dispositive motions, and any settlement offers are preferably identified. Optionally, sensitivity analysis and other specialized risk analysis functions are performed. In addition, the computerized custom risk assessment templates may be configured to interface with a user's existing database software programs and encryption algorithms may be used to limit template access to authorized users.

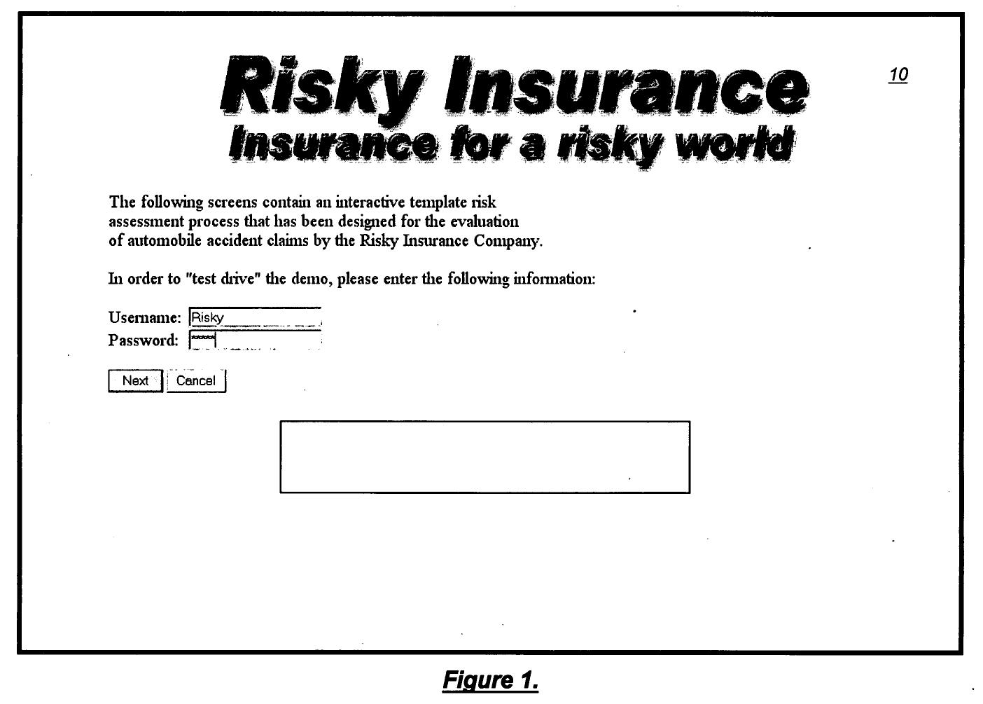

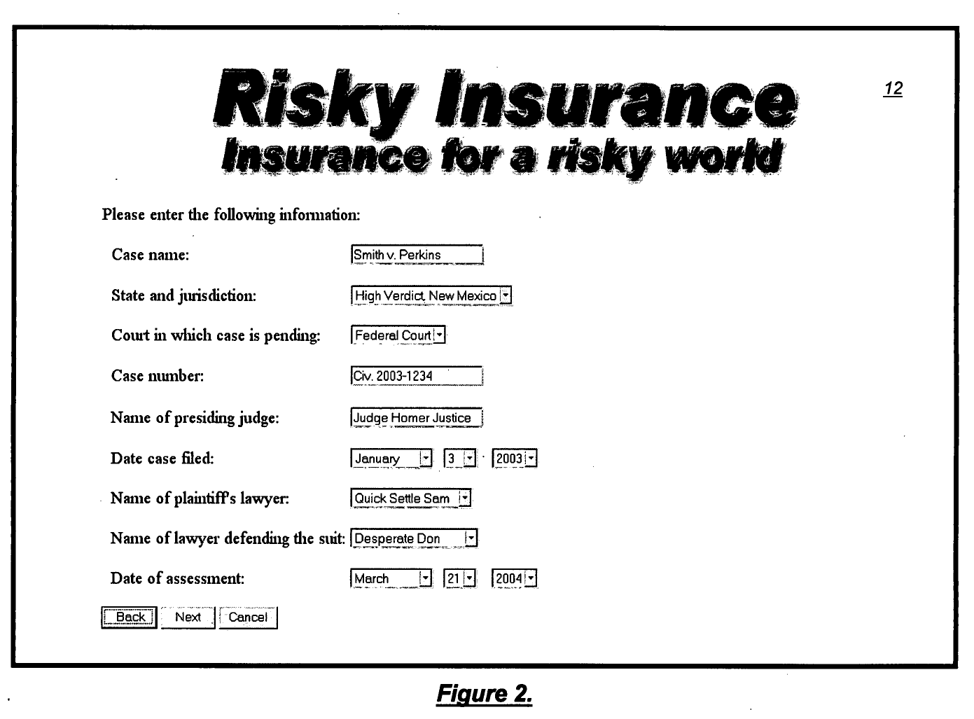

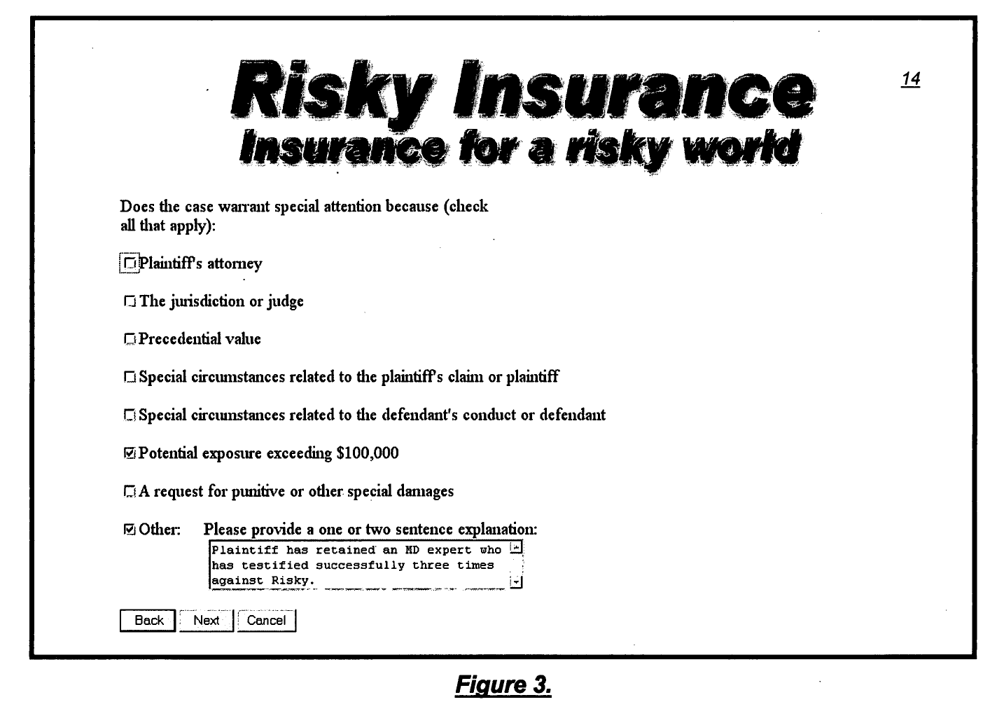

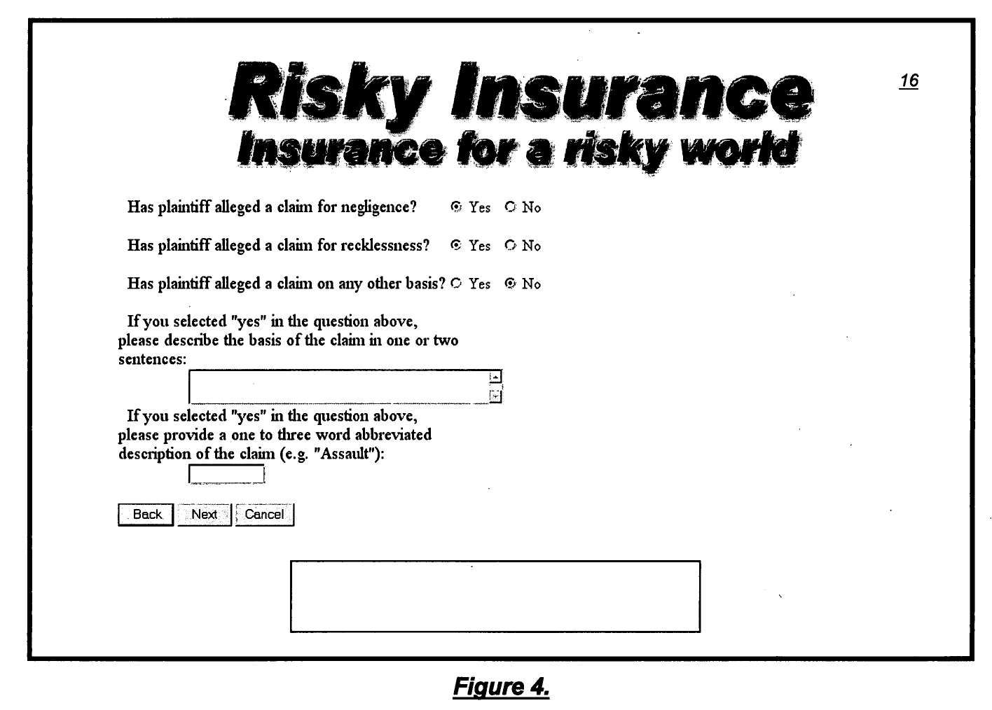

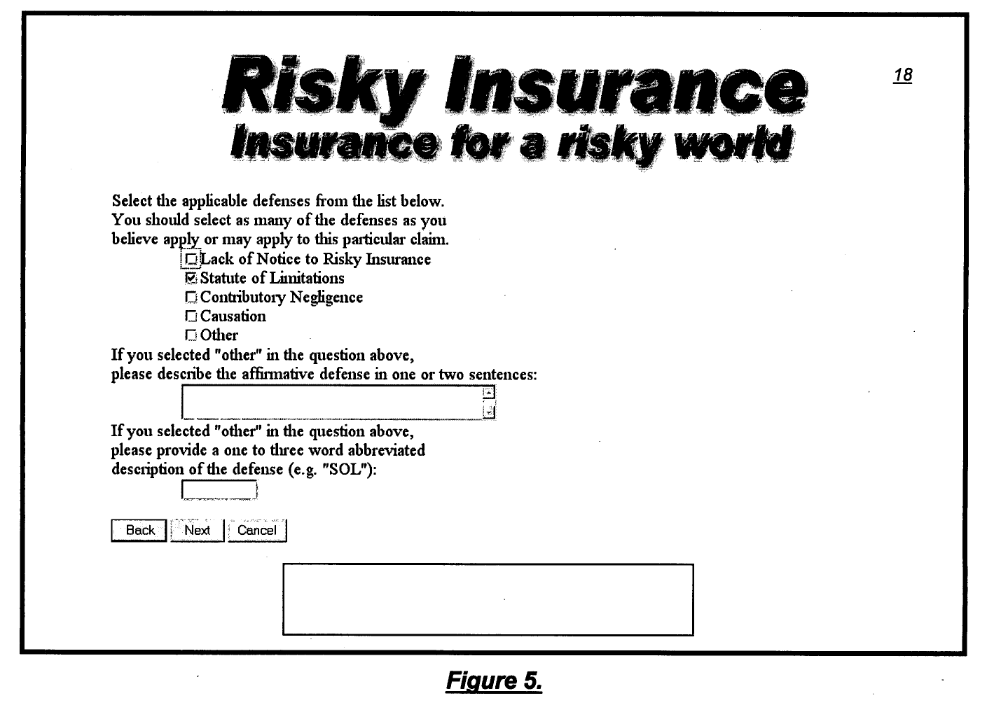

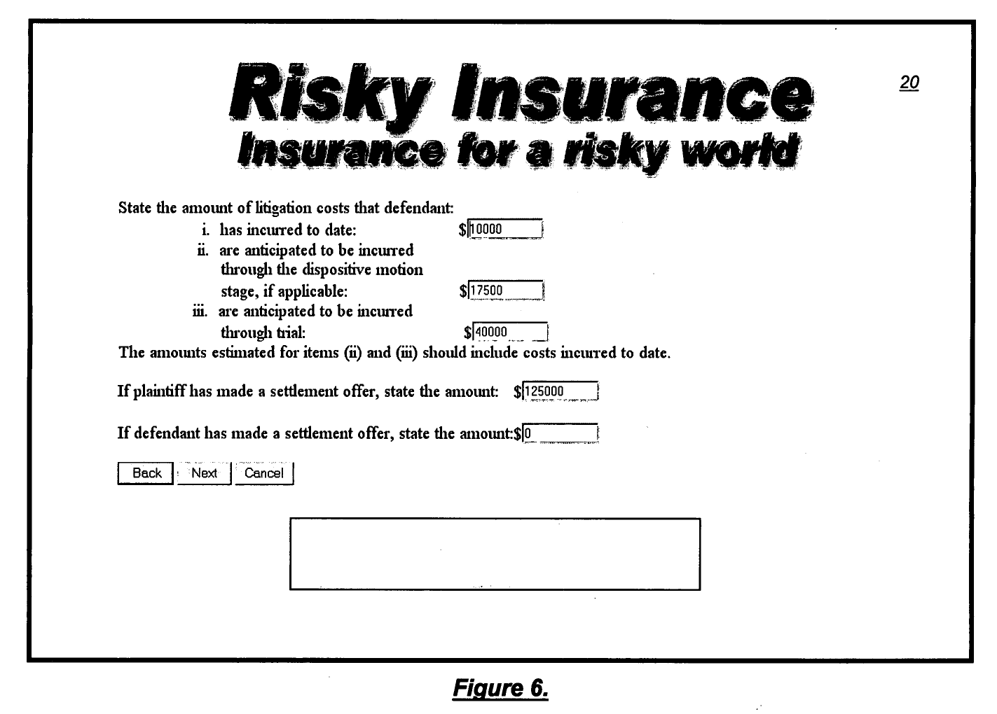

Referring now to FIGS. 1-6, in one exemplary embodiment of the present invention, a plurality of input display screens associated with the computerized custom risk assessment templates of the present invention request risk assessment information from a user. This risk assessment information is then used to create and/or select and modify the functionality and appearance of subsequently-displayed decision analysis tools. For example, a risk assessment template first prompts a user to enter a username and password in order to gain access (display screen 10, FIG. 1). The risk assessment template then prompts the user to enter claim/case identification information (display screen 12, FIG. 2), such as the claim/case name, the jurisdiction and forum, the claim/case identification number, the presiding official, the claim/case filing date, the claimant's representative, the defendant's representative, the risk assessment date, etc. The risk assessment template further prompts the user to enter special attention information (display screen 14, FIG. 3), such as information regarding a given claim or case warranting special attention because of the identity of the claimant's representative, the identity of the presiding official, the precedential value of the claim or case, special circumstances associated with the claimant, special circumstances associated with the defendant, potential exposure exceeding a given dollar amount, the possibility of punitive or other special damages being awarded, etc. Following the prompt for special attention information, the risk assessment template prompts the user to enter claim/case type information (display screen 16, FIG. 4), such as whether or not the claimant has raised a negligence issue, a recklessness issue, etc. The risk assessment template then prompts the user to enter applicable defense information (display screen 18, FIG. 5), such as the applicability of a lack of notice defense, a statute of limitations defense, a contributory negligence defense, a causation defense, etc. The risk assessment template further prompts the user to enter cost/settlement information (display screen 20, FIG. 6), such as the costs incurred by defendant to date, the estimated costs to be incurred by defendant through a dispositive motion, the estimated costs to be incurred by defendant through a hearing or trial, the amount of any settlement offer made by claimant, the amount of any settlement offer made by defendant, etc.

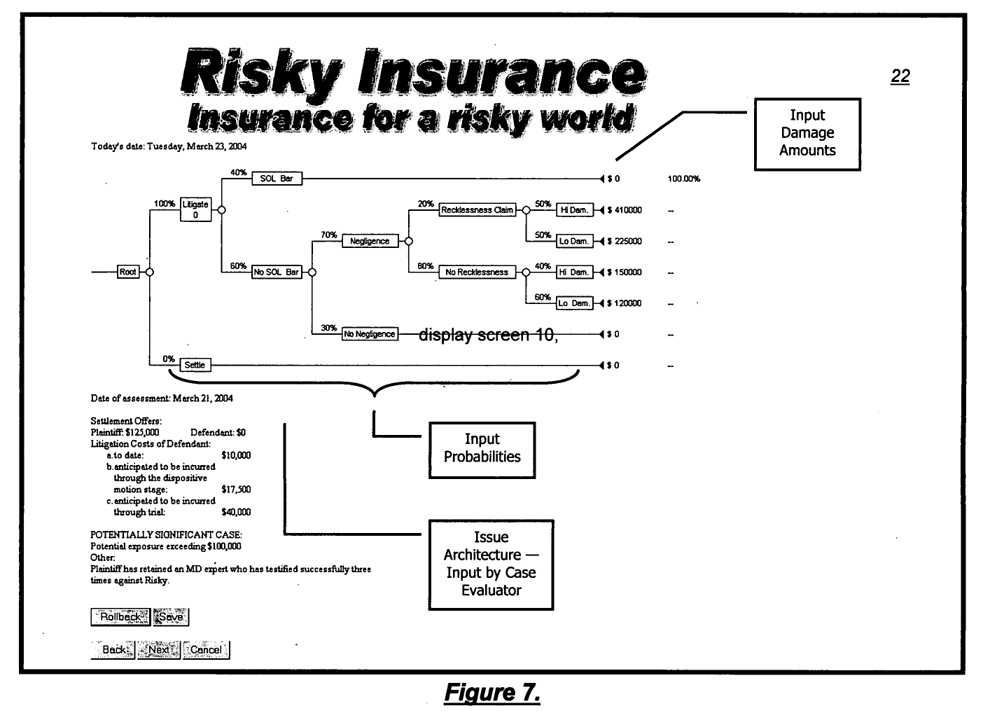

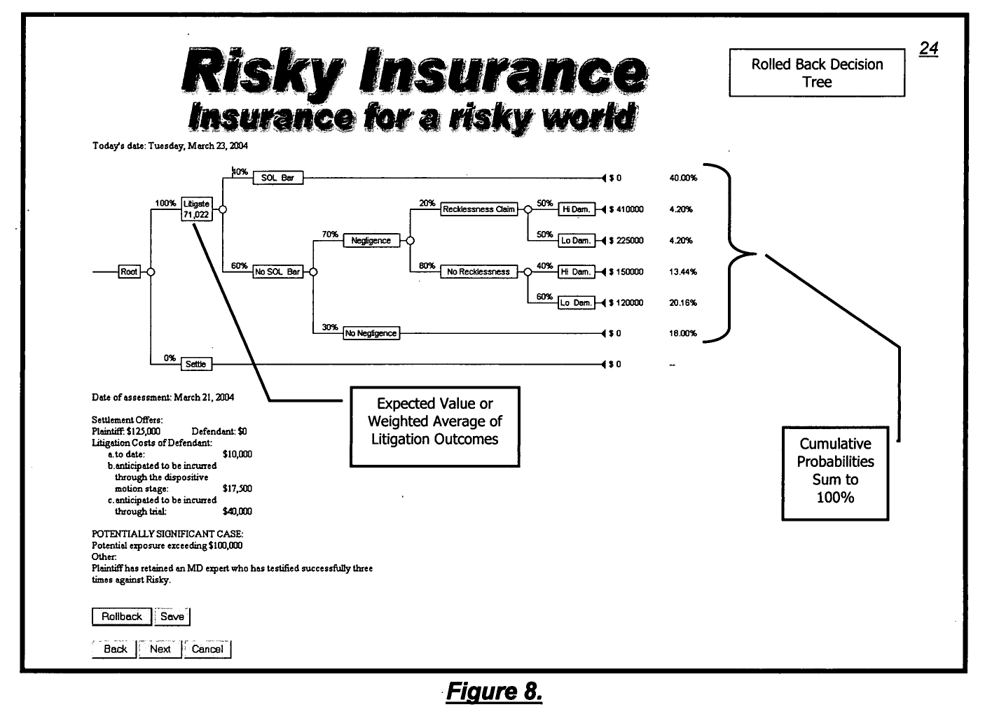

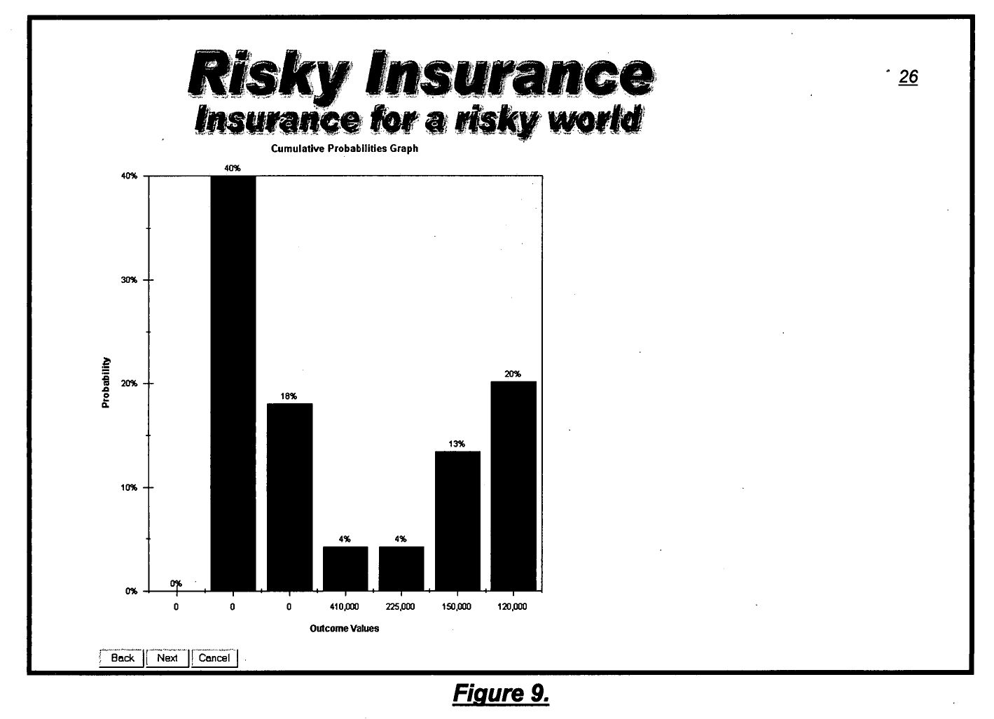

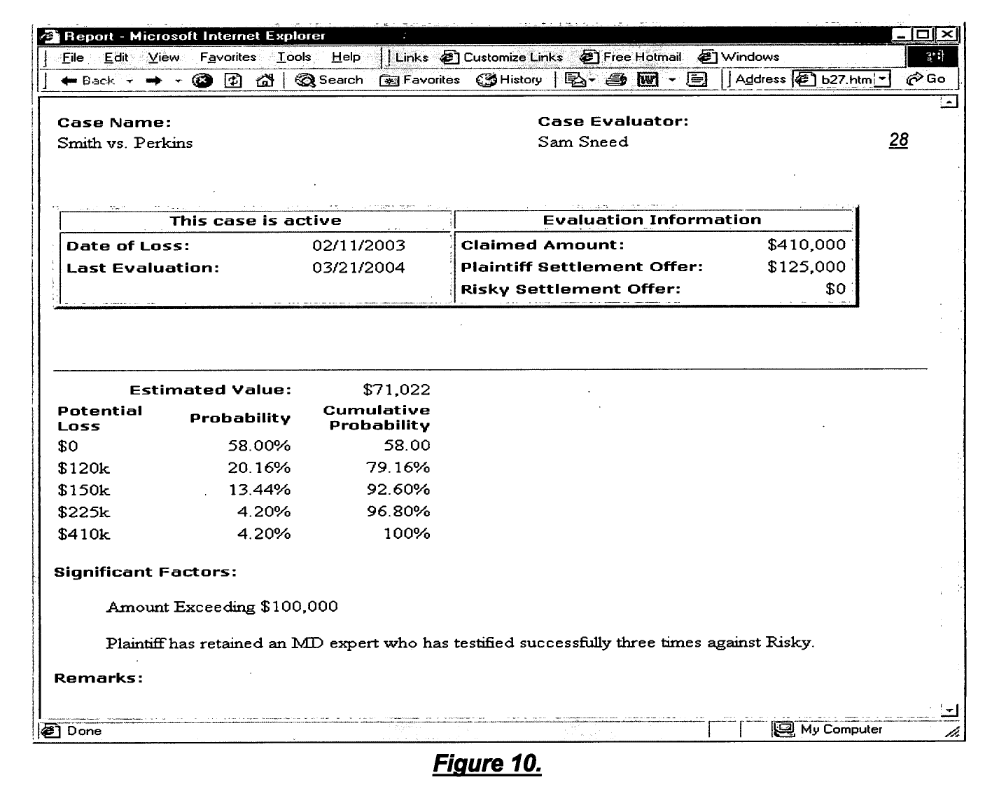

Referring now to FIGS. 7-10, based upon this risk assessment information, the risk assessment template creates one or more custom decision trees and other decision analysis tools providing a wealth of decision analysis information. These one or more custom decision trees are designed and formulated for a specific dispute, claim, or case, displaying the “issue architecture” for the dispute, claim, or case. For example, the one or more custom decision trees display the claim/case identification information, special attention information, claim/case type information, applicable defense information, and/or cost/settlement information described above (display screens 22 and 24, FIGS. 7 and 8). The one or more custom decision trees also display the issue architecture, the input probabilities, the input damage amounts, the expected value or weighted average of potential outcomes, the cumulative probabilities of potential outcomes, etc. (display screens 22 and 24, FIGS. 7 and 8). A cumulative probabilities graph (display screen 26, FIG. 9), an estimated claim/case summary table (display screen 28, FIG. 10), and/or the like may also be generated.

The list of possible inputs/outputs provided above is intended to be exemplary, and should not be construed in any way to be limiting.

In the litigation risk assessment context, multiple defendants are common. In medical malpractice cases, for example, a plaintiff who claims to have been injured during a surgery performed in a hospital will frequently sue the hospital, the surgeon, any other doctors involved in the surgery or subsequent treatment, the nursing staff, a medical device manufacturer, a drug company, etc. Typically, it is in the best interest of these co-defendants to build a joint position. The co-defendants benefit collectively and individually if they can agree on whether or not settlement is desirable, on what terms, and on how any settlement monies or damage awards would be apportioned. Unfortunately, differences in risk assessments sometimes prevent co-defendants from reaching such a joint position.

In various exemplary embodiments, the present invention provides computerized collaborative risk assessment templates that assist co-defendants or the like in reaching a joint position. Using a plurality of questions and decision analysis tools, the computerized collaborative risk assessment templates guide each co-defendant individually through a disciplined and careful evaluation of a litigation or the like. Each co-defendant individually maps out the “issue architecture” involved and uses their knowledge and experience to assess the probable resolution of each of the issues.

Each co-defendant creates a documented “risk profile” for the litigation or the like that identifies, among other things: 1) each of the issues and issue relationships; 2) the alternative outcomes of each of the issues and the percentage probability of each of the alternative outcomes; 3) the dollar value and cumulative percentage probability of each of the alternative outcomes; and 4) the “expected value” (risk-adjusted weighted average) of the alternative outcomes. The computerized collaborative risk assessment templates then combine the analyses of each of the co-defendants into a single decision tree, which displays the issues in a common and structured manner. Each of the co-defendants' individual probability predictions and dollar outcome estimates are displayed on the decision tree. Through color coding and labeling, the co-defendants' evaluations are placed side by side. Such positioning facilitates comparison and discussion. The co-defendants may then identify areas of agreement and areas of significant disagreement.

Through the use of the computerized collaborative risk assessment templates of the present invention, obstacles that inhibit movement towards a joint position are removed. Individual positions are no longer blurred by the inherent fuzziness of shifting linguistic descriptions. Each co-defendant's position is clearly identified in the common decision tree and the semantic traps that can sabotage discussions are avoided. Optionally, the computerized collaborative risk assessment templates also incorporate and use sensitivity analysis to separate differences that are significant and that have a substantial impact on the potential outcome from those that are insignificant.

In general, the computerized collaborative risk assessment templates of the present invention allow co-defendants to perform a joint risk evaluation of a claim or case, using mutually agreed upon percentage probabilities and potential outcome dollar amounts. The results of this joint risk evaluation may be used to formulate a settle or litigate position, and to benchmark an appropriate settlement dollar amount.

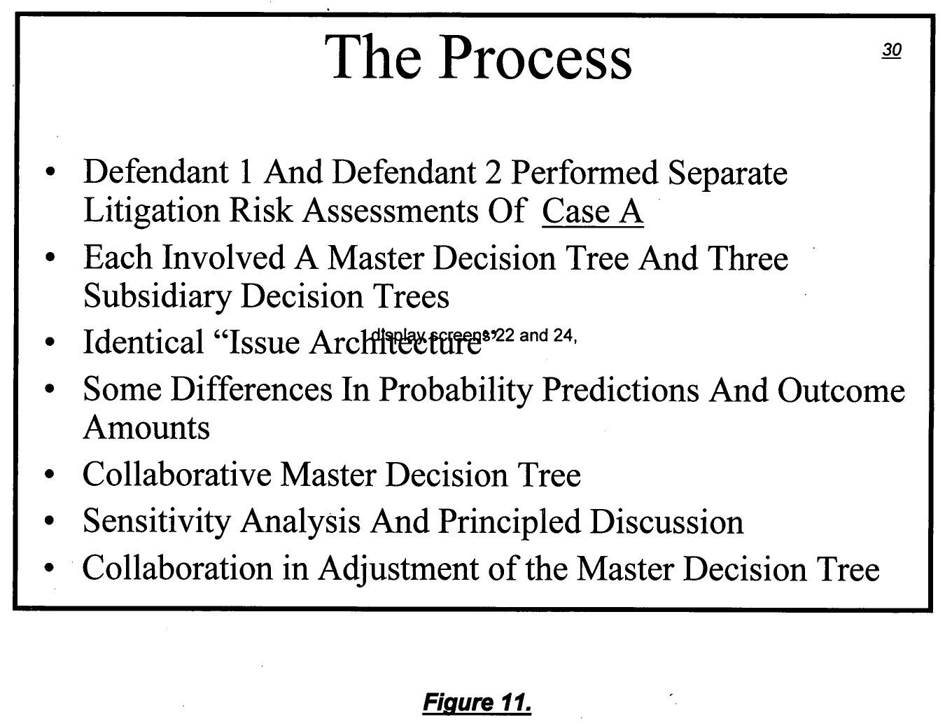

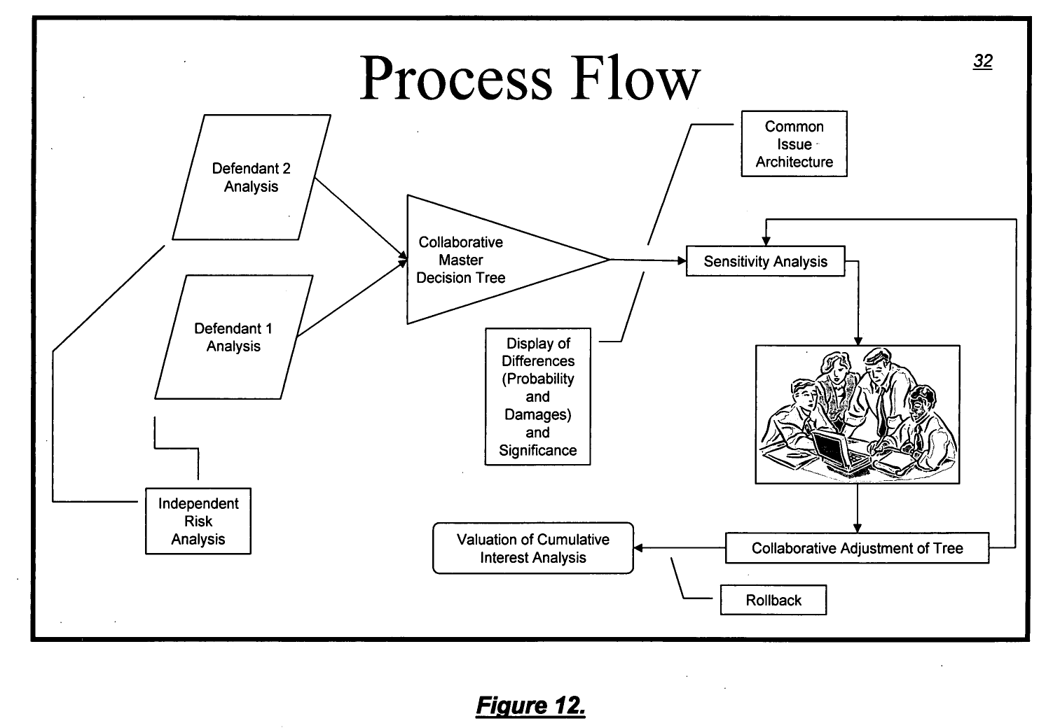

Referring now to FIGS. 11 and 12, in another exemplary embodiment of the present invention, a plurality of input display screens 30 and 32 associated with the computerized collaborative risk assessment templates of the present invention request risk assessment information from a plurality of users. This risk assessment information is then used to select and modify the functionality and appearance of subsequently-displayed decision analysis tools. Referring to FIG. 11, in this collaborative embodiment, for example, two co-defendants performed separate litigation risk assessments of a given case, each litigation risk assessment involving a master decision tree and three subsidiary decision trees. The co-defendants used identical “issue architectures”, however there were some differences in probability predictions and outcome amounts. The master decision trees and subsidiary decision trees were combined into a single collaborative master decision tree and a sensitivity analysis was performed. Further collaboration allowed for the adjustment of the collaborative master decision tree. This process is illustrated in the flowchart of FIG. 12.

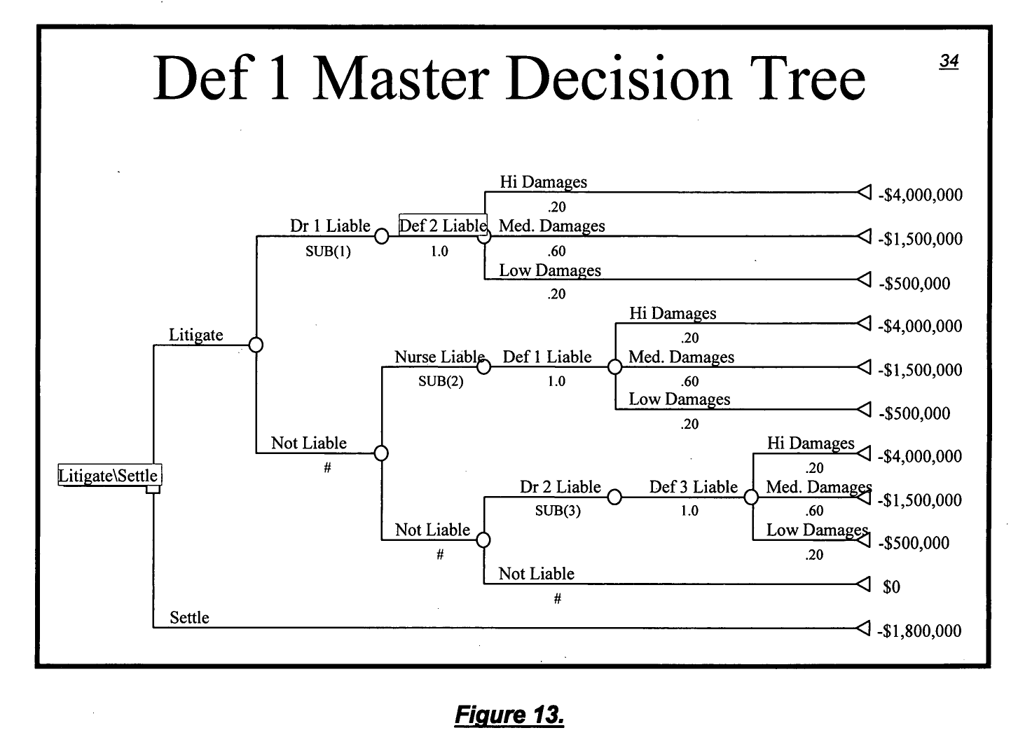

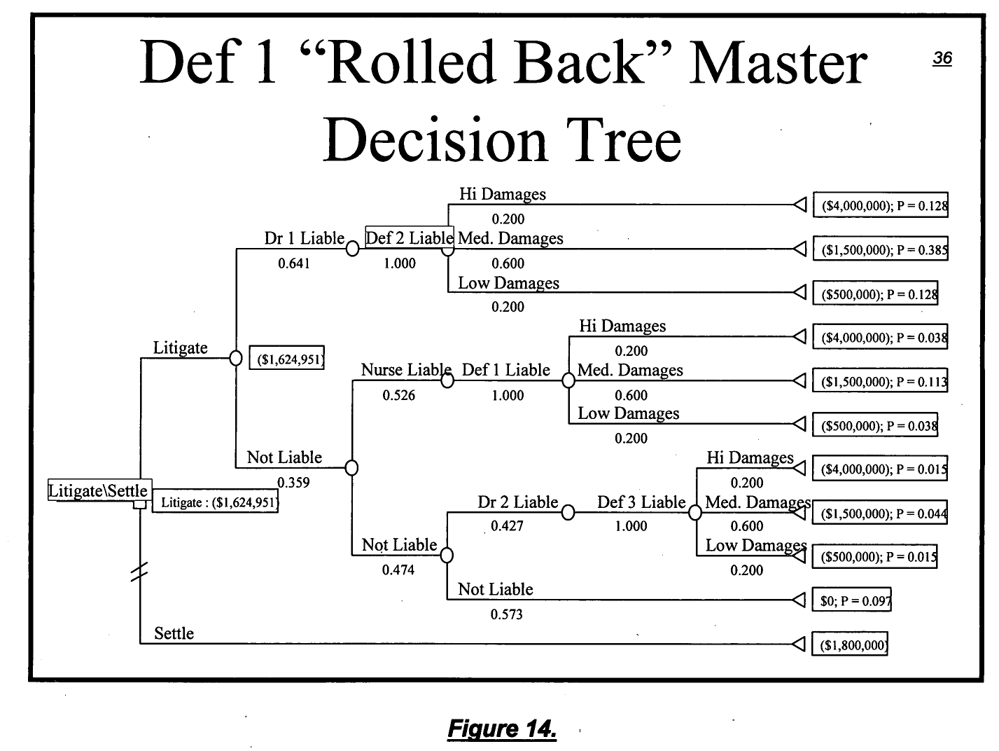

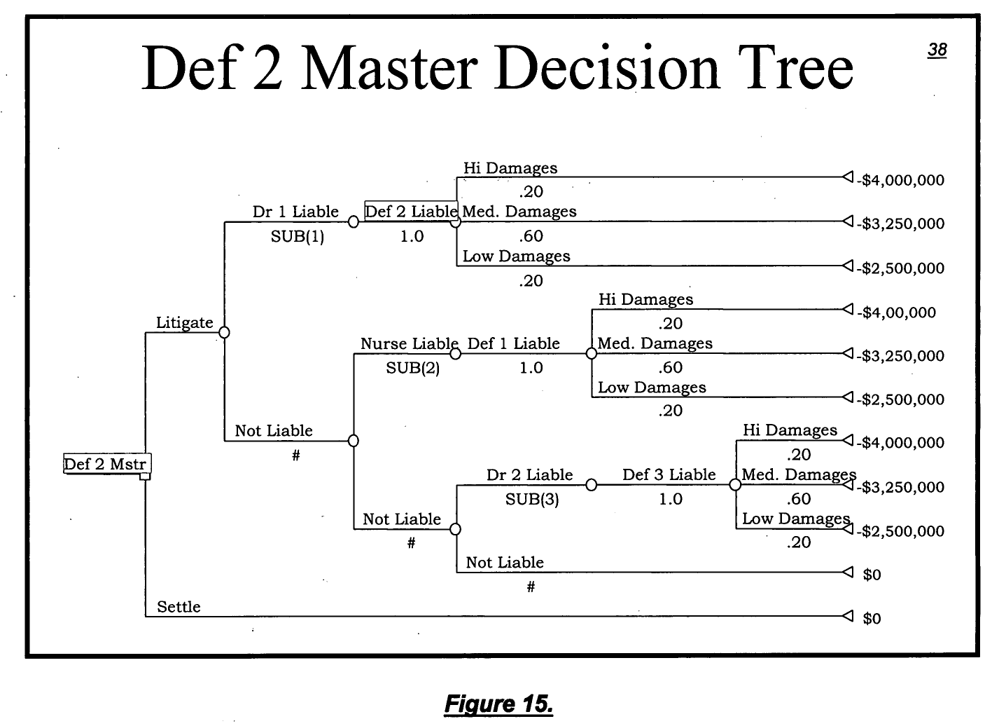

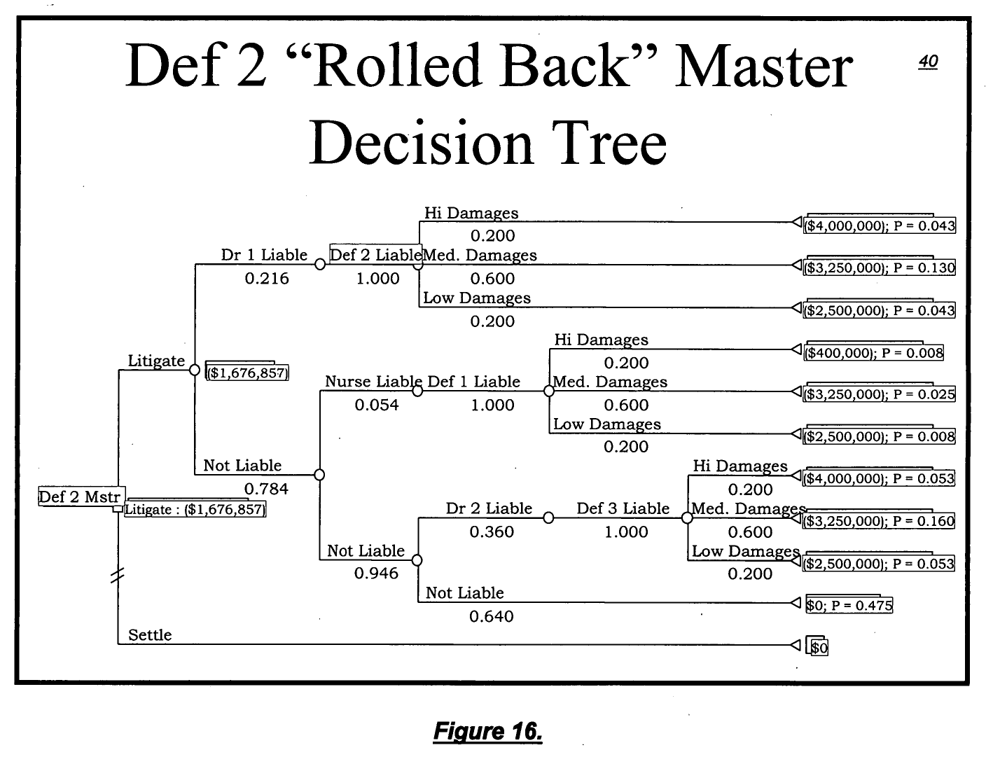

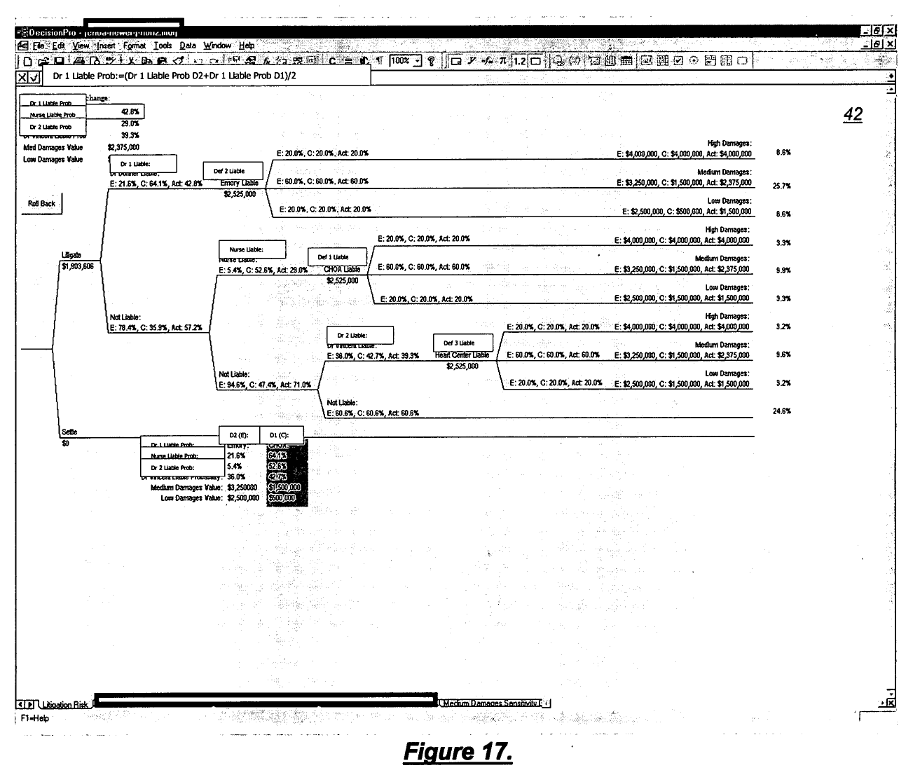

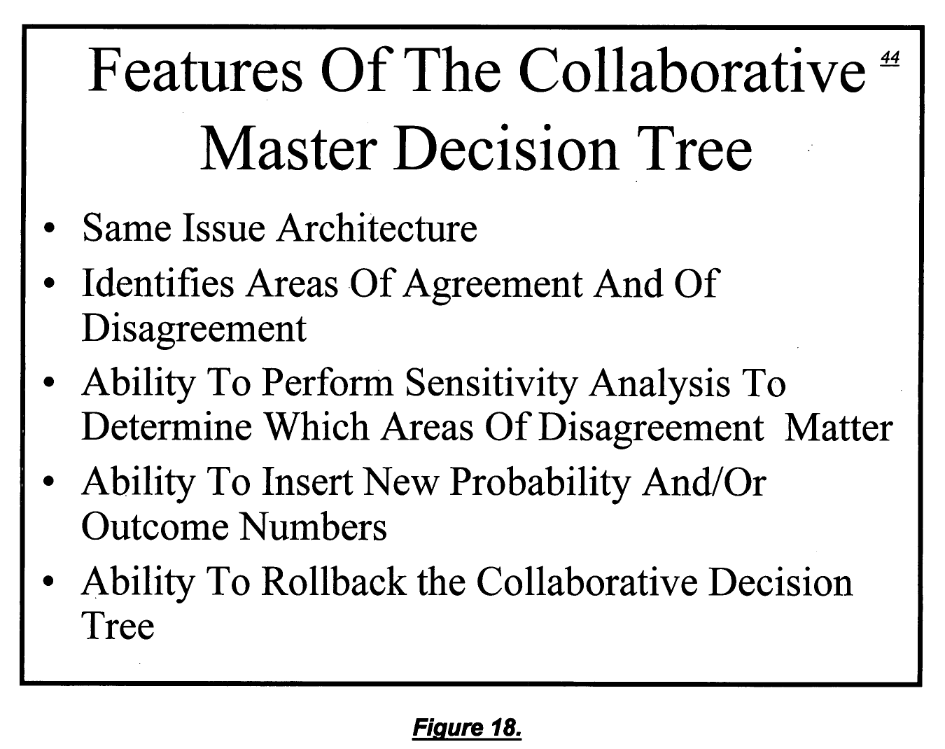

Referring now to FIGS. 13-18, a plurality of master decision trees are illustrated. FIG. 13 illustrates a first co-defendant master decision tree 34 including litigate and settle options, potentially liable parties, and variable damage categories. FIG. 14 illustrates a first co-defendant “rolled back” master decision tree 36. FIG. 15 illustrates a second co-defendant master decision tree 38 including litigate and settle options, potentially liable parties, and variable damage categories. FIG. 16 illustrates a second co-defendant “rolled back” master decision tree 40. Finally, FIG. 17 illustrates a collaborative master decision tree 42 generated by the computerized collaborative risk assessment system of the present invention. As stated in the display screen 44 of FIG. 18, the advantages of the collaborative master decision tree of the present invention are that identical “issue architectures” are used, areas of agreement and significant disagreement are identified, sensitivity analysis may be performed to determine which areas of disagreement matter, new probability and/or outcome numbers may be inserted, and the collaborative master decision tree may be rolled back.

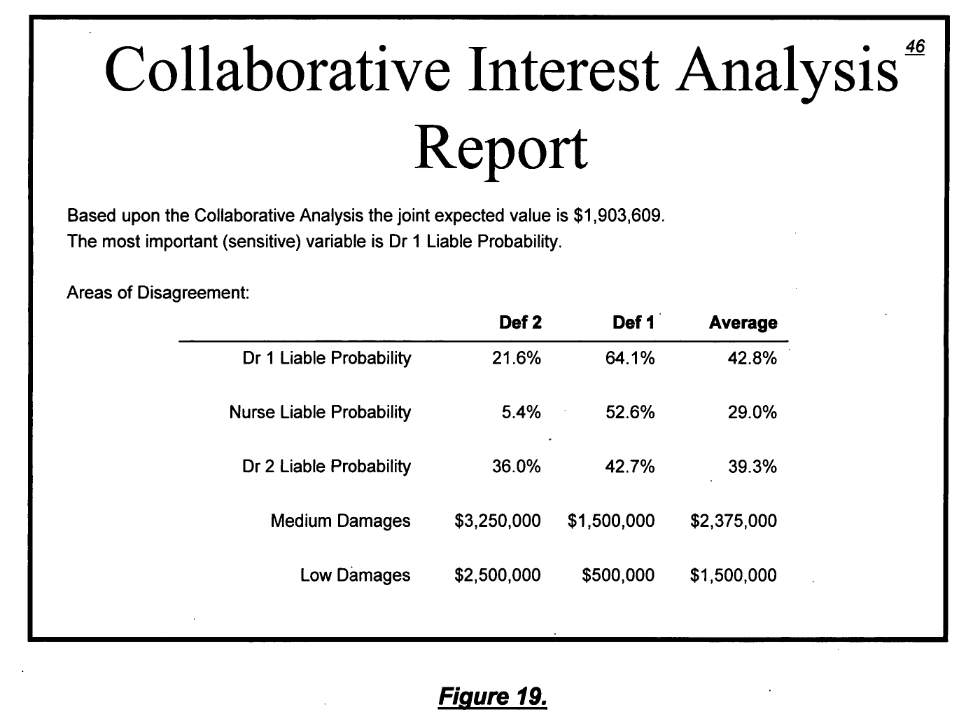

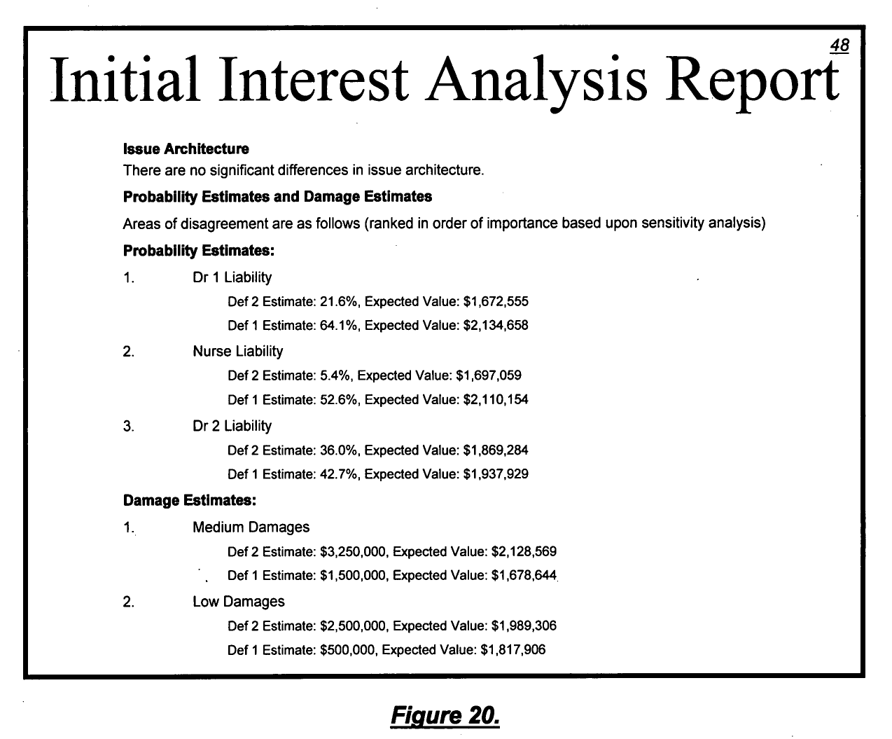

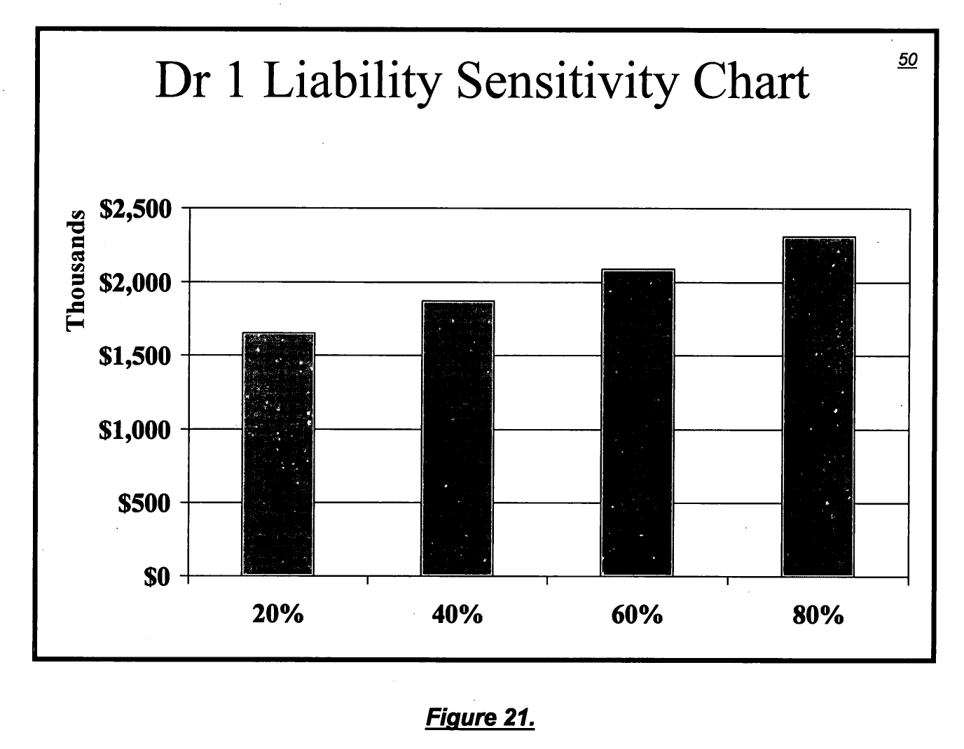

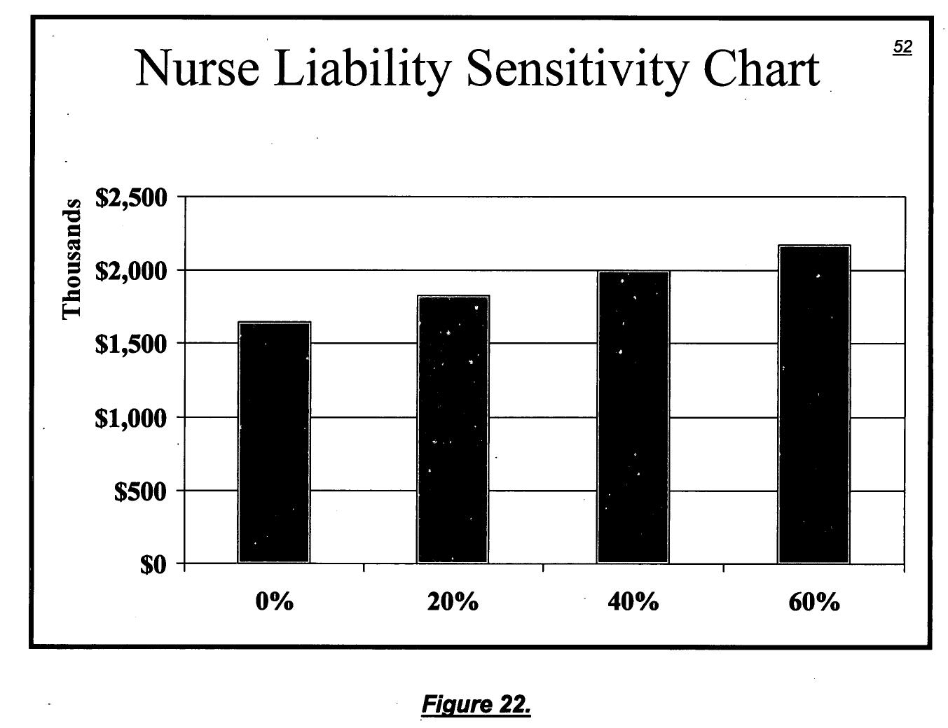

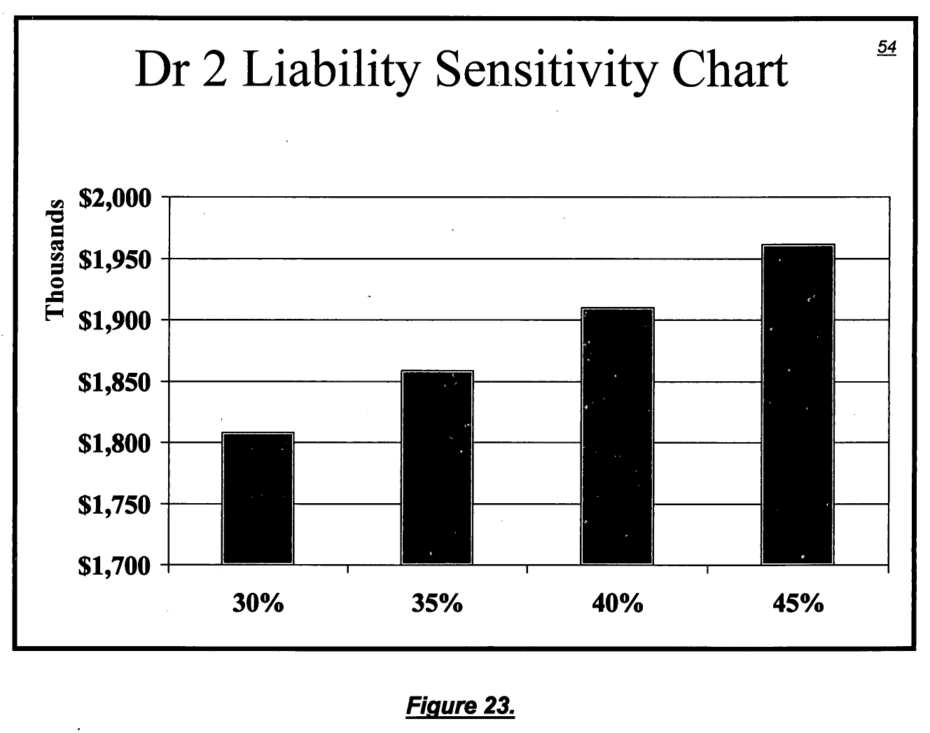

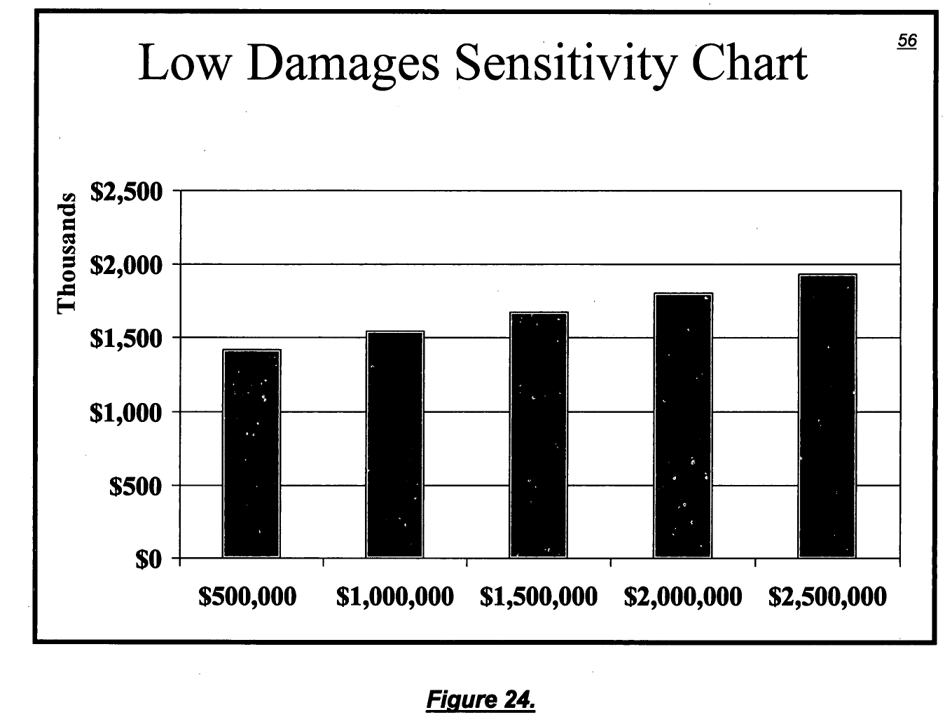

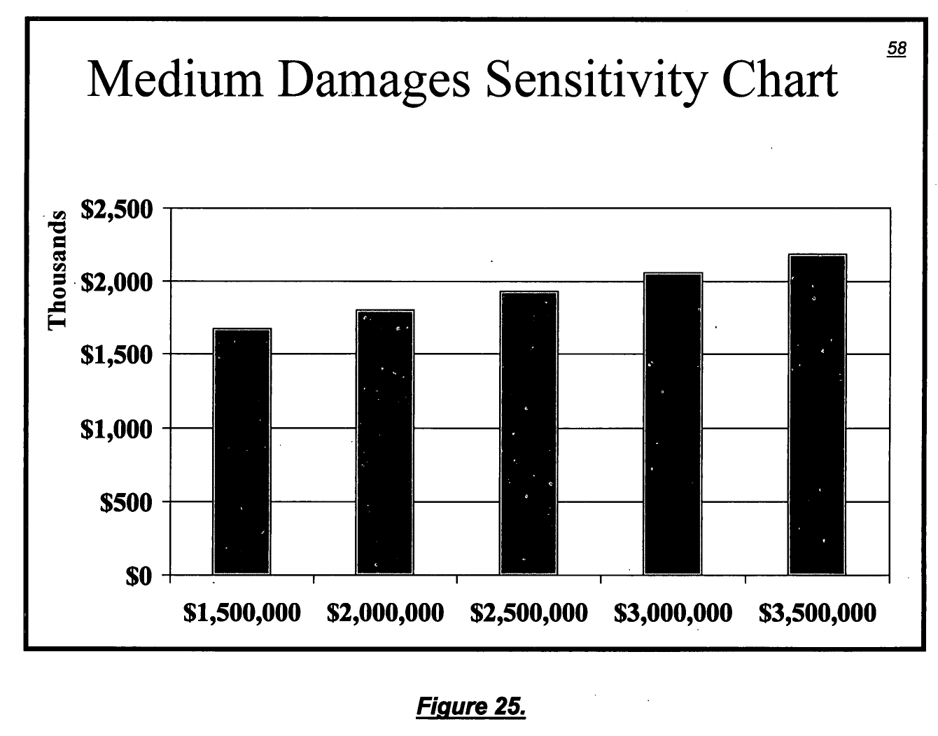

Referring now to FIGS. 19-25, a plurality of exemplary system outputs are illustrated, including a collaborative interest analysis report 46 (FIG. 19), an initial interest analysis report 48 (FIG. 20), and a plurality of sensitivity charts 50, 52, 54, 56, and 58 (FIGS. 21-25).

Optionally, the computerized custom and collaborative risk assessment templates of the present invention also provide decision-making information to one or more users, such as at each issue or uncertainty node. This decision-making information may include, for example, case comparables and the like. Further, the computerized custom and collaborative risk assessment templates of the present invention may incorporate and utilize a data mining tool or algorithm that supplies input information for the one or more users, including probabilities, dollar amounts, etc., based on similar disputes, claims, and/or cases.

Although the present invention has been illustrated and described with reference to preferred embodiments and examples thereof, it will be readily apparent to those of ordinary skill in the art that other embodiments and examples may perform similar functions and/or achieve similar results. All such equivalent embodiments and examples are within the spirit and scope of the present invention and are intended to be covered by the following claims.

What is claimed is:

1. A computerized method for assessing and evaluating the issues and risks associated with a project in a custom manner, comprising:
presenting a plurality of questions related to the issues and risks associated with the project to a user;
receiving a plurality of answers related to the issues and risks associated with the project from the user;
in the event that one or more custom decision analysis tools are not already created, creating one or more custom decision analysis tools based upon the answers related to the issues and risks associated with the project received from the user;
in the event that one or more custom decision analysis tools are already created, selecting and modifying the functionality and appearance of one or more existing decision analysis tools based upon the answers related to the issues and risks associated with the project received from the user; and
displaying the one or more created and/or selected and modified decision analysis tools to the user for subsequent issue and risk assessment and evaluation by the user.

2. The method of claim 1, wherein the plurality of questions related to the issues and risks associated with the project comprise a plurality of questions selected from the group consisting of one or more username and password queries, one or more claim/case identification queries, one or more special attention queries, one or more claim/case type queries, one or more applicable defense queries, and one or more cost/settlement queries.

3. The method of claim 1, wherein the plurality of answers related to the issues and risks associated with the project comprise a plurality of questions selected from the group consisting of one or more username and password answers, one or more claim/case identification answers, one or more special attention answers, one or more claim/case type answers, one or more applicable defense answers, and one or more cost/settlement answers.

4. The method of claim 1, wherein the one or more decision analysis tools comprise one or more decision analysis tools selected from the group consisting of a decision tree, a Monte Carlo simulation, a forecasting method, a linear or nonlinear programming optimization method, and a sensitivity analysis.

5. The method of claim 1, wherein the project comprises one of a claim and a case associated with one of a potential litigation and a litigation.

6. A computerized system for assessing and evaluating the issues and risks associated with a project in a custom manner, comprising:
output means for presenting a plurality of questions related to the issues and risks associated with the project to a user;
input means for receiving a plurality of answers related to the issues and risks associated with the project from the user;
processing means for, in the event that one or more custom decision analysis tools are not already created, creating one or more custom decision analysis tools based upon the answers related to the issues and risks associated with the project received from the user;
processing means for, in the event that one or more custom decision analysis tools are already created, selecting and modifying the functionality and appearance of one or more existing decision analysis tools based upon the answers related to the issues and risks associated with the project received from the user; and
display means for displaying the one or more created and/or selected and modified decision analysis tools to the user for subsequent issue and risk assessment and evaluation by the user.

7. The system of claim 6, wherein the plurality of questions related to the issues and risks associated with the project comprise a plurality of questions selected from the group consisting of one or more username and password queries, one or more claim/case identification queries, one or more special attention queries, one or more claim/case type queries, one or more applicable defense queries, and one or more cost/settlement queries.

8. The system of claim 6, wherein the plurality of answers related to the issues and risks associated with the project comprise a plurality of questions selected from the group consisting of one or more username and password answers, one or more claim/case identification answers, one or more special attention answers, one or more claim/case type answers, one or more applicable defense answers, and one or more cost/settlement answers.

9. The system of claim 6, wherein the one or more decision analysis tools comprise one or more decision analysis tools selected from the group consisting of a decision tree, a Monte Carlo simulation, a forecasting method, a linear or nonlinear programming optimization method, and a sensitivity analysis.

10. The system of claim 6, wherein the project comprises one of a claim and a case associated with one of a potential litigation and a litigation.

11. A computerized method for assessing and evaluating the issues and risks associated with a project in a collaborative manner, comprising:
presenting a plurality of questions related to the issues and risks associated with the project to a plurality of users;
receiving a plurality of answers related to the issues and risks associated with the project from the plurality of users;
in the event that one or more collaborative decision analysis tools are not already created, creating one or more collaborative decision analysis tools based upon the answers related to the issues and risks associated with the project received from the plurality of users;
in the event that one or more collaborative decision analysis tools are already created, selecting and modifying the functionality and appearance of one or more existing decision analysis tools based upon the answers related to the issues and risks associated with the project received from the user; and
displaying the one or more created and/or selected and modified decision analysis tools to the plurality of users for subsequent issue and risk assessment and evaluation by the plurality of users.

12. The method of claim 11, wherein the plurality of questions related to the issues and risks associated with the project comprise a plurality of questions selected from the group consisting of one or more username and password queries, one or more claim/case identification queries, one or more special attention queries, one or more claim/case type queries, one or more applicable defense queries, and one or more cost/settlement queries.

13. The method of claim 11, wherein the plurality of answers related to the issues and risks associated with the project comprise a plurality of questions selected from the group consisting of one or more username and password answers, one or more claim/case identification answers, one or more special attention answers, one or more claim/case type answers, one or more applicable defense answers, and one or more cost/settlement answers.

14. The method of claim 11, wherein the one or more decision analysis tools comprise one or more decision analysis tools selected from the group consisting of a decision tree, a Monte Carlo simulation, a forecasting method, a linear or nonlinear programming optimization method, and a sensitivity analysis.

15. The method of claim 11, wherein the project comprises one of a claim and a case associated with one of a potential litigation and a litigation.

16. A computerized system for assessing and evaluating the issues and risks associated with a project in a collaborative manner, comprising:
output means for presenting a plurality of questions related to the issues and risks associated with the project to a plurality of users;
input means for receiving a plurality of answers related to the issues and risks associated with the project from the plurality of users;
processing means for, in the event that one or more collaborative decision analysis tools are not already created, creating one or more collaborative decision analysis tools based upon the answers related to the issues and risks associated with the project received from the plurality of users;
processing means for, in the event that one or more collaborative decision analysis tools are already created, selecting and modifying the functionality and appearance of one or more existing decision analysis tools based upon the answers related to the issues and risks associated with the project received from the user; and
display means for displaying the one or more created and/or selected and modified decision analysis tools to the plurality of users for subsequent issue and risk assessment and evaluation by the plurality of users.

17. The system of claim 16, wherein the plurality of questions related to the issues and risks associated with the project comprise a plurality of questions selected from the group consisting of one or more username and password queries, one or more claim/case identification queries, one or more special attention queries, one or more claim/case type queries, one or more applicable defense queries, and one or more cost/settlement queries.

18. The system of claim 16, wherein the plurality of answers related to the issues and risks associated with the project comprise a plurality of questions selected from the group consisting of one or more username and password answers, one or more claim/case identification answers, one or more special attention answers, one or more claim/case type answers, one or more applicable defense answers, and one or more cost/settlement answers.

19. The system of claim 16, wherein the one or more decision analysis tools comprise one or more decision analysis tools selected from the group consisting of a decision tree, a Monte Carlo simulation, a forecasting method, a linear or nonlinear programming optimization method, and a sensitivity analysis.

20. The system of claim 16, wherein the project comprises one of a claim and a case associated with one of a potential litigation and a litigation.
